(19) United States
(12) Patent Application Publication
(10) Pub. No.: US 2017/0282238 A1
(43) Pub. Date: Oct. 5, 2017

(54) FASTENER FEED APPARATUS

(71) Applicant: Whitesell Formed Components, Inc., Waterford, MI (US)

(72) Inventors: Jeffrey C. Lewis, Addison Township, MI (US); Srecko Zdravkovic, Sterling Heights, MI (US)

(21) Appl. No.: 15/090,576

(22) Filed: Apr. 4, 2016

(51) Int. Cl. B21J 15/32; B23P 19/00; B25B 23/04

(52) U.S. Cl. CPC B21J 15/323; B25B 23/045; B23P 19/001

(57) ABSTRACT

A feed apparatus for feeding fasteners to a fastener installation head includes a chute to support and guide a strip of fasteners from a chute inlet to the fastener installation head. The strip of fasteners includes a plurality of fasteners selectably releasably attached to a carrier ribbon, wherein the feed apparatus is to separate the fasteners from the carrier ribbon and present the fasteners to the fastener installation head for installation. An idler wheel is to peel the carrier ribbon from the fasteners as the fasteners pass through the chute. A tensioner is to advance the carrier ribbon and apply tension to the carrier ribbon to advance the fasteners in the chute. An actuator is to urge the tensioner to advance the carrier ribbon.

### BACKGROUND

Some self-attaching fasteners are attachable to panels without welding. As used herein, the term self-attaching fastener includes male and female self-piercing and self-clinching fasteners which are permanently attached to a panel. Examples of self-attaching fasteners include pierce and clinch studs, bolts and the like; and pierce and clinch nuts and other female fasteners of this type. Self-attaching fasteners include a fastener portion, such as a threaded or unthreaded shank portion in the case of male fasteners, or a threaded or unthreaded bore in the case of female fasteners.

The term “self-piercing fastener” as used herein refers to a self-attaching fastener in which the barrel portion is to pierce an opening in the panel. The term “self-clinching fastener” as used herein refers to a self-attaching fastener that is permanently installable in an opening that is preformed in the panel prior to inserting the self-clinching fastener into the preformed opening.

Some self-attaching fasteners are used in mass production of products. Many instances of a self-attaching fastener may be installed in rapid succession from an automated installation head. Automatic systems have been used to feed fasteners into the automated installation head. For example, in some existing automatic feed systems, gravity propels fasteners into an installation head from a funnel-shaped hopper filled with fasteners. Fasteners in hoppers may be randomly oriented, requiring alignment and orientation of the fasteners prior to installation by the installation head.

### SUMMARY

A feed apparatus for feeding fasteners to a fastener installation head includes a chute to support and guide a strip of fasteners from a chute inlet to the fastener installation head. The strip of fasteners includes a plurality of fasteners selectably releasably attached to a carrier ribbon, wherein the feed apparatus is to separate the fasteners from the carrier ribbon and present the fasteners to the fastener installation head for installation. An idler wheel is to peel the carrier ribbon from the fasteners as the fasteners pass through the chute. A tensioner is to advance the carrier ribbon and apply tension to the carrier ribbon to advance the fasteners in the chute. An actuator is to urge the tensioner to advance the carrier ribbon.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a semi-schematic cross-sectional side view of an example of a feed apparatus of the present disclosure depicting a feed path of a strip of fasteners from a reel through a chute of the feed apparatus into an installation head;

FIG. 2 is a semi-schematic cutaway side view of a strip of fasteners wound on a reel according to an example of the present disclosure;

FIG. 3 is a semi-schematic bottom view of an example of a portion of a strip of fasteners with the fasteners adhesively attached to a carrier ribbon according to the present disclosure;

FIG. 4 is a semi-schematic side view of the example of the portion of the strip of fasteners depicted in FIG. 3 according to the present disclosure;

FIG. 5 is a semi-schematic top perspective view of an example of a portion of a strip of fasteners with each fastener resiliently retained in an aperture defined in a plastic carrier ribbon according to the present disclosure;

FIG. 6 is a semi-schematic bottom perspective view of the example of the portion of a strip of fasteners depicted in FIG. 5;

FIG. 7 is a semi-schematic side view of a carrier ribbon being peeled from a fastener according to the present disclosure;

FIG. 8A is a perspective view of an example of a cylindrical self-piercing fastener according to the present disclosure;

FIG. 8B is a perspective view of an example of an octagonal self-piercing fastener according to the present disclosure;

FIG. 8C is a perspective view of an example of a cylindrical fastener according to the present disclosure;

FIG. 8D is a perspective view of an example of a hexagonal fastener according to the present disclosure;

FIG. 8E is a bottom view of an example of another cylindrical self-piercing fastener according to the present disclosure;

FIG. 8F is a side view of the example of the cylindrical self-piercing fastener depicted in FIG. 8E;

FIG. 9 is a bottom perspective view of a prior art strip of self-piercing fasteners with embedded wires connecting the rectangular connectors;

FIG. 10 is a semi-schematic cross-sectional side view of another example of a feed apparatus of the present disclosure depicting a feed path of a strip of fasteners from a reel through a chute of the feed apparatus into an installation head;

FIG. 11 is a top view of an example of a feed apparatus of the present disclosure;

FIG. 12 is a side view of the example of the feed apparatus depicted in FIG. 11;

FIG. 13 is a cross-sectional view taken along line 13-13 depicted in FIG. 11;

FIG. 14 is a perspective view of the example of the feed apparatus depicted in FIG. 11;

FIG. 15 is a bottom perspective view of the example of the feed apparatus depicted in FIG. 11;

FIG. 16 a top view of another example of a feed apparatus of the present disclosure;

FIG. 17 is an end view of the example of the feed apparatus depicted in FIG. 16;

FIG. 18 is a cross-sectional view taken along line 18-18 depicted in FIG. 16;

FIG. 19 is a bottom perspective view of the example of the feed apparatus depicted in FIG. 16;

FIG. 20 is a top view of the example of the feed apparatus depicted in FIG. 16 with a strip of fasteners being fed into the feed apparatus from a reel that is level wound with the strip of fasteners; and

FIG. 21 is a semi-schematic perspective cutaway view of a ball bearing assembly.

### DETAILED DESCRIPTION

Some fasteners, for example, pierce nuts, are used in mass production applications such as in the production of automobiles. In some production applications, it is advantageous to “string” (or join) fasteners together to feed the fasteners into an installation apparatus. Joining fasteners to form a strip of fasteners may simplify the design of a fastener feed system compared to feeding from a hopper. In an existing fastener feed system, a feed mechanism is used to feed a fastener strip into an installation head of an installation apparatus. The existing installation apparatus shears the metal wires that join the fasteners together to release one of the fasteners from the fastener strip and joins the fastener to a panel. The fastener may be joined to the panel by piercing the fastener through the panel and, thereafter, deforming a portion of fastener and/or the panel, thereby causing the fastener to engage the panel to securely join the fastener to the panel.

An existing installation system may be located in a die press (not shown) capable of generating several tons of force. The installation apparatus reciprocates vertically. On the downward stroke of reciprocation, a punch separates the fastener from the fastener strip and forces the fastener through the panel. A die receives the fastener and deforms the fastener to cause the fastener to positively engage and retain the panel. On the upward stroke, the feed mechanism places the next fastener beneath the punch thereby readying the installation apparatus for the next fastener installation into the panel.

In the existing system, the fastener strip is supplied to the feed mechanism by way of a reel. The fastener strip includes a plurality of individual fasteners, each of which are joined together in a common orientation. Individual fasteners are joined by one or more wires.

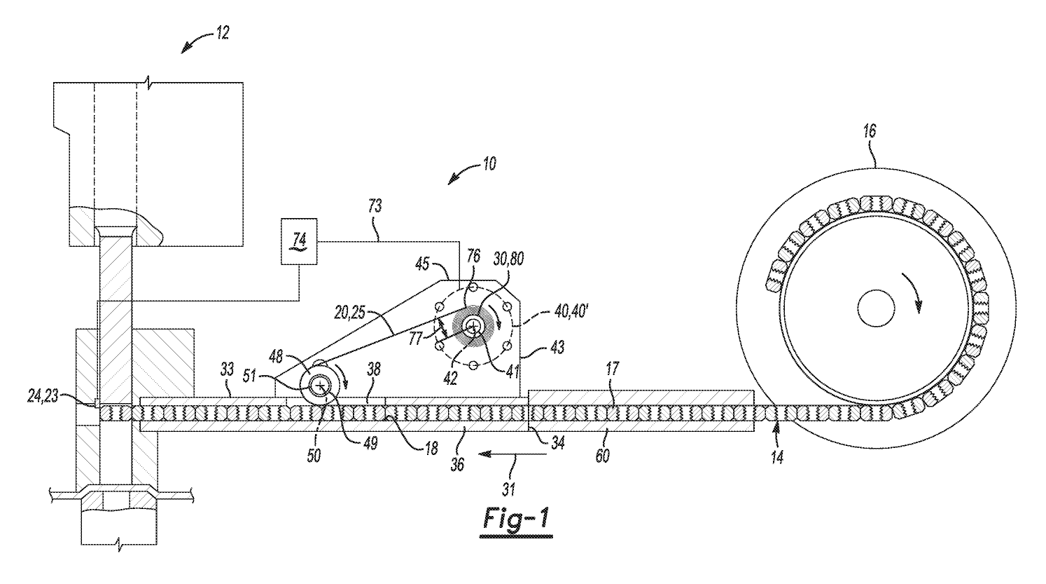

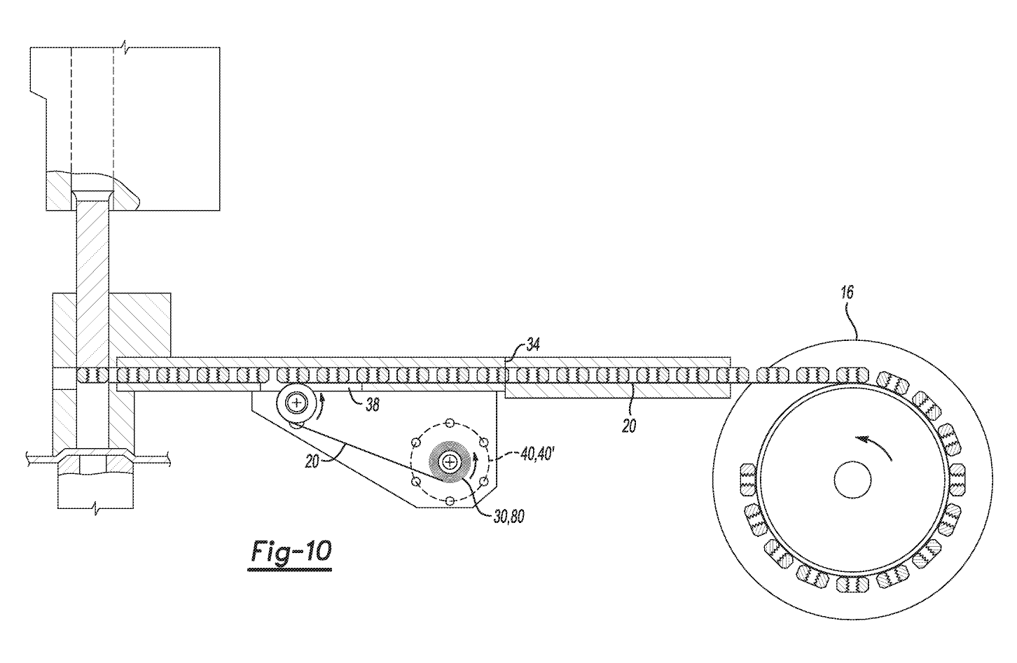

FIG. 1 is a semi-schematic cross-sectional side view of an example of the present disclosure. A feed apparatus 10 for feeding fasteners 17 to a fastener installation head 12 is depicted. FIG. 10 shows a feed path of a strip 14 of fasteners 17 from a reel 16 through a fastener alignment trough 60 and a chute 36 of another example of the feed apparatus 10. In examples of the present disclosure, the feed apparatus 10 includes the chute 36 to support and guide the strip 14 of fasteners 17 from a chute inlet 34 to the fastener installation head 12. The strip 14 of fasteners 17 may be unwound from a reel 16 to be drawn into the chute inlet 34.

The feed apparatus 10 is to separate the fasteners 17 from the carrier ribbon 20 and present the fasteners 17 to the fastener installation head 12 for installation. An idler wheel 48 is to peel the carrier ribbon 20 from the fasteners 17 as the fasteners 17 pass through the chute 36. A tensioner 30 is to advance the carrier ribbon 20 and apply tension to the carrier ribbon 20 to advance the fasteners 17 in the chute 36. The actuator 40 is to urge the tensioner 30 to advance the carrier ribbon 20. The actuator 40 may urge the tensioner by applying a force or a torque. For example, the tensioner 30 may be a take-up spool 80 as depicted in FIG. 1 to wind up the carrier ribbon 20 and apply tension to the carrier ribbon 20 to advance the fasteners 17 in the chute 36. The actuator 40 may be a rotary actuator 40′ to urge the take-up spool 80 by applying torque to the take-up spool 80 and causing the take-up spool 80 to advance the carrier ribbon 20 by turning the take-up spool 80.

In other examples, the tensioner 30 may be any device to serve as an interface for the actuator 40 and the carrier ribbon 20 to transfer the force or torque from the actuator 40 to the carrier ribbon 20. The tensioner 30 may include a friction pad, rocker pawl, cogwheel or other interface that is compatible with the carrier ribbon 20. For example, the tensioner 30 may be a pinch roller driven by the actuator 40. In examples, the empty carrier ribbon may be wound on a take-up spool 80, or the empty carrier ribbon may be routed, cut or uncut, to a collection bin for convenient disposition.

In the example depicted in FIG. 1, as the empty carrier ribbon 20 winds onto the take-up spool 80, the control system 74 may compensate for the effective radius 77 of the take-up spool 80. The effective radius 77 of the take-up spool 80 is the distance from the actuator shaft axis 42 to the point of tangency 76 where the path of the carrier ribbon 20 extends toward the idler wheel 48. The effective radius 77 may be sensed by a follower lever, or by a non-contacting sensor. The effective radius 77 may be calculated based on the thickness of the carrier ribbon 20 and a number of rotations experienced by the actuator 40. In an example, the actuator 40 may be a rotary actuator 40′ with a rotary encoder (not shown) integrated into the rotary actuator 40′. The effective radius 77 may be calculated based on the number of fasteners that are fed into the installation head relative to the number of turns or partial turns of the rotary actuator 40′.

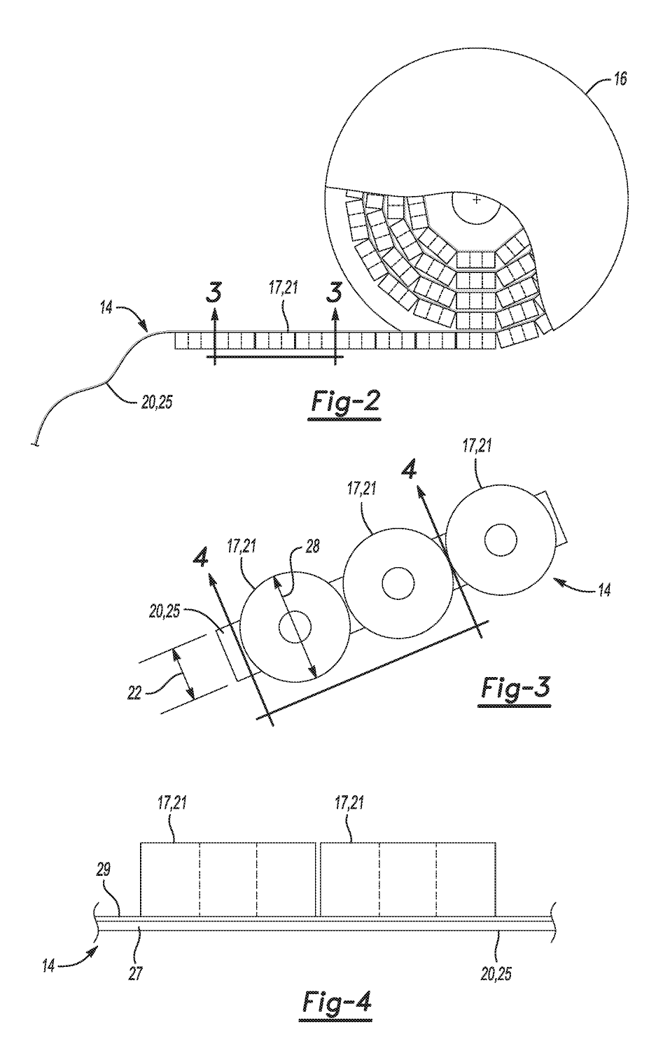

In the example depicted in FIG. 2-FIG. 4, the strip 14 of fasteners 17 includes a plurality 21 of fasteners 17 adhesively disposed on a carrier ribbon 20. The carrier ribbon 20 may be a plastic substrate 27 with an adhesive layer 29 disposed thereon. In other words, the carrier ribbon 20 may be a strip of adhesive tape 25. The carrier ribbon 20 may have a ribbon width 22 that is smaller than a transverse dimension 28 of the fasteners 17. In other examples the carrier ribbon 20 may be wider than the transverse dimension 28 of the fasteners 17.

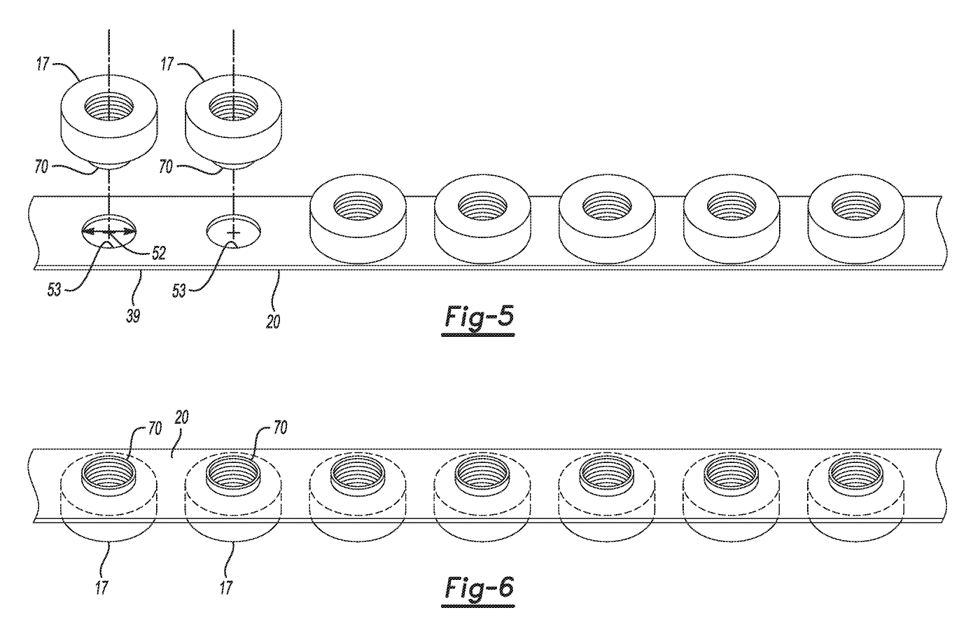

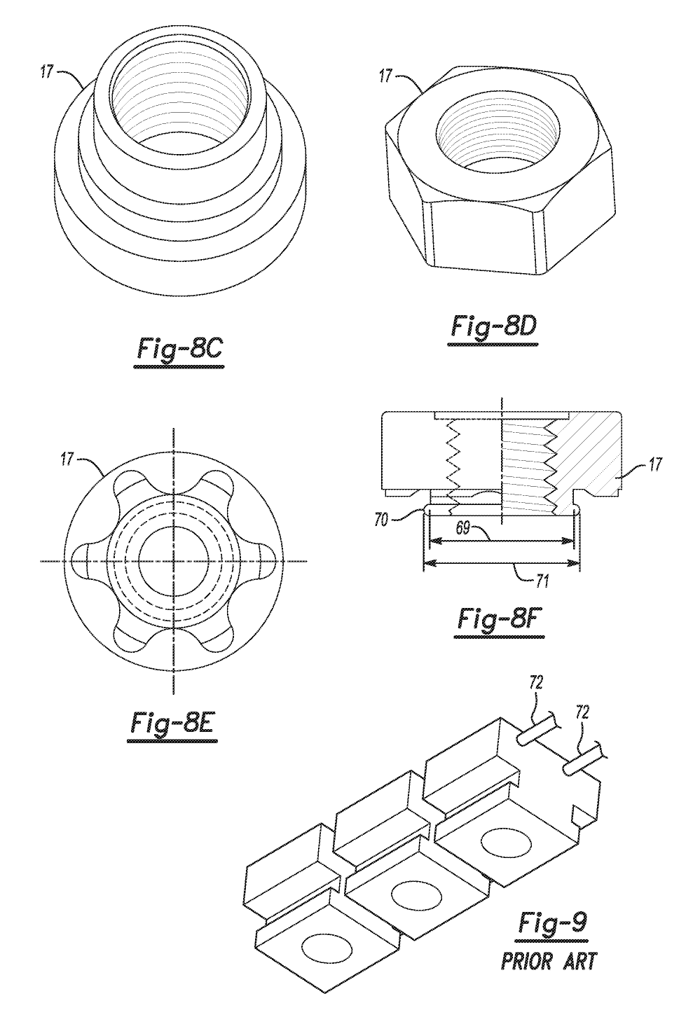

As shown in FIGS. 5-7, the carrier ribbon 20 may be a flat plastic ribbon 39 with a plurality of retention apertures 53 defined therein. Each fastener 17 is disposed in a respective retention aperture 53 and selectably releasably retained therein by resilience of the carrier ribbon 20. For example, in a free state, a retention diameter 52 of the retention aperture 53 may be smaller than a neck 69 (e.g. FIG. 8F) of a fastener 17. The fastener 17 has a pilot portion 70 with a pilot diameter 71 larger than the retention diameter 52. The pilot portion 70 of the fastener 17 is pressed into the respective retention aperture 53, causing the carrier ribbon 20 to stretch around the pilot portion 70 and to resiliently constrict around the neck 69 of the fastener 17. Thus, the fastener 17 is retained in the retention aperture 53. The fastener 17 is selectably releasable from the carrier ribbon 20 by peeling the carrier ribbon 20 away from the fastener 17.

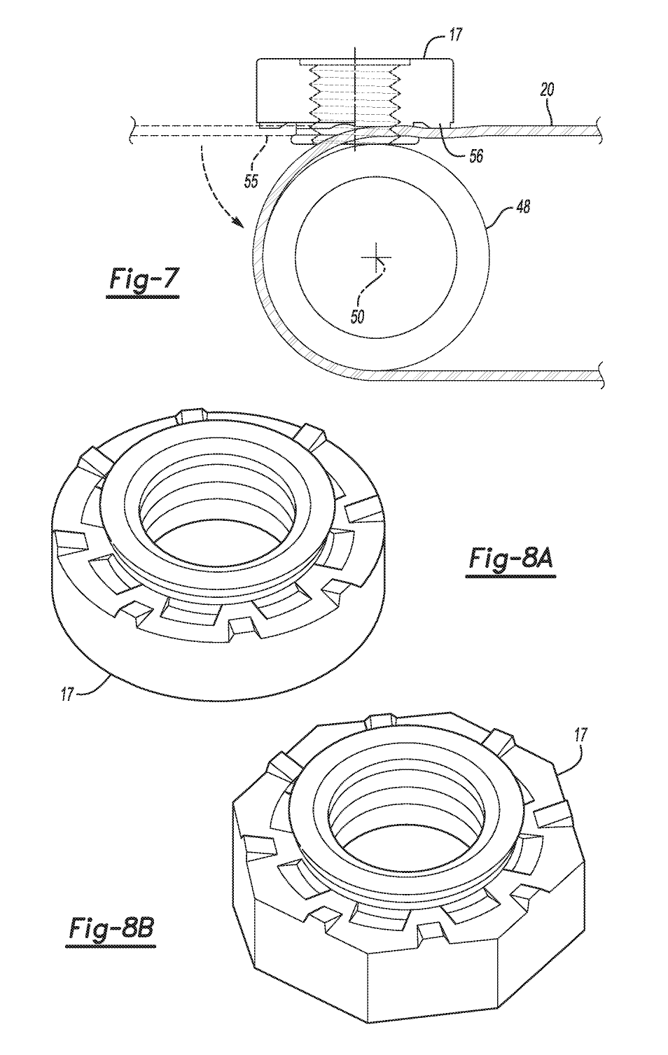

As used herein, peeling the carrier ribbon 20 from the fasteners 17 means pulling on a leading end 55 of the carrier ribbon 20, curling the carrier ribbon 20 around the idler wheel 48, and separating the carrier ribbon 20 from the fastener 17 beginning at a leading end 55 of the fastener 17 and ending at a trailing end 56 of the fastener 17 as the carrier ribbon 20 advances past the idler wheel 48. See, for example, FIG. 7. Peeling the carrier ribbon 20 is not the same as punching the fastener 17 away from the carrier ribbon 20, or prying the fastener 17 off of a straight portion of the carrier ribbon 20. FIG. 7 depicts peeling the flat plastic ribbon 39 with a plurality of retention apertures 53 shown in FIG. 5 and FIG. 6. However, it is to be understood that peeling an adhesive tape 25 from the fastener 17 would be similarly described. Furthermore, fasteners 17 that are attached to the carrier ribbon 20 by any suitable means, (e.g. spots of adhesive, welding, or mechanical holders) may be selectably released from the carrier ribbon 20 by peeling as disclosed herein.

As depicted in FIGS. 8A, 8C and 8F, examples of the fasteners 17 may be cylindrical fasteners. As shown in FIG. 8D, examples of the fasteners may be hexagonal. In examples, the fasteners 17 may be polygonal as depicted in FIG. 8D (hexagonal) and FIG. 8B (octagonal). In examples of the present disclosure, the fasteners 17 may be rectangular. FIG. 9 is a bottom perspective view of a prior art strip of self-piercing fasteners with embedded wires 72 connecting the rectangular fasteners. The embedded wires 72 are sheared prior to installation of the prior art self-piercing fastener. Examples of rectangular fasteners of the present disclosure may be similar to the fasteners shown in FIG. 9 except the fasteners of the present disclosure are not joined by wires. The fasteners 17 of the present disclosure are advantageously free of burrs when presented to the fastener installation head 12 because there is no embedded wire carrier. Further, the fasteners of the present disclosure may present a weight savings because there is no additional weight from the carrier ribbon 20 after the fastener 17 is installed. Since the prior art fasteners have the wire carriers 72 embedded in the body of the fasteners, the embedded portion of the wire carrier 72 remains in the fastener after installation. Examples of the fasteners 17 of the present disclosure may be self-clinching or self-piercing fasteners. In other examples, the fasteners may be common hex nuts (FIG. 8D) presented one at a time for installation.

Referring back to FIG. 1, the chute 36 has an aperture 38 defined in a top surface 33. The carrier ribbon 20 is to be drawn through the aperture 38 and over the idler wheel 48, thereby peeling the carrier ribbon 20 from the fasteners 17 in seriatim. The aperture 38 has a width 35 transverse to a feed direction 31 of the chute 36. The width 35 (see FIG. 11) of the aperture 38 may be smaller than a transverse dimension 28 (see FIG. 3) of the fasteners 17 to prevent the fasteners 17 from being withdrawn through the aperture 38. In other examples, the fastener 17 may be small enough to fit through the aperture 38, however the idler wheel 48 may force the fasteners 17 to be flat against a guide surface 18 of the chute 36 when the carrier ribbon 20 is peeled from the fastener 17.

A support bracket 45 is rigidly attached on a side 46 of the chute 36 to support an axle 51 of the idler wheel 48. The axle 51 of the idler wheel 48 has an idler axis 50 orthogonal to the feed direction 31 of the chute 36. The idler wheel 48 may include an internal bearing 49. The axle 51 may be spring loaded to urge the idler wheel 48 against the fasteners 17 as the fasteners 17 advance past the idler wheel 48.

An actuator support bracket 43 is fixedly attached to the chute 36. As depicted in FIG. 1, the actuator support bracket 43 may be integrated with the support bracket 45 for the idler wheel 48. The actuator 40 is mounted to the actuator support bracket 43. The actuator 40 has an actuator shaft 41 having an actuator shaft axis 42 orthogonal to a feed direction 31 of the chute 36. The tensioner 30 may be removably mounted on the actuator shaft 41 for advancement therewith. In examples in which the actuator 40 is a rotary actuator 40′ and the tensioner 30 is a take-up spool 80, the take-up spool 80 may be removably mounted on the actuator shaft 41 for rotation therewith. The take-up spool 80 may have guide flanges 32 as depicted in FIG. 11, or no guide flanges as depicted in FIG. 1.

As used herein, “actuator” means a type of motor that is responsible for moving or controlling a mechanism or system. An actuator is operated by a source of energy, typically electric current, hydraulic fluid pressure, or pneumatic pressure, and converts that energy into motion. In examples of the present disclosure, the actuator 40 may be a rotary actuator 40′. In other examples, the actuator 40 may be a linear actuator. The actuator 40 may include a ball screw mechanism, ratchet mechanism, cam mechanism, gear drive, roller mechanism, solenoid, piston, geartrain, cogwheel, pulley/drive belt, or any actuating device for advancing the carrier ribbon 20 after separation of the carrier ribbon 20 from the fasteners 17, and for applying tension to the carrier ribbon 20 to advance the fasteners 17 in the chute 36.

The actuator 40 may be an electric motor. The actuator 40 may be an air motor. The actuator 40 may actuate the tensioner 30 in response to a control signal 73. In an example, the rotary actuator 40′ may apply torque to the take-up spool 80 in response to a control signal 73. The control signal 73 may be independent of a stroke of the fastener installation head 12. In some existing fastener feed systems with embedded carrier wires, the stroke of the fastener installation head 12 provides the force to advance the fasteners by one fastener per stroke. In other words, as the fastener installation head 12 moves up and down, a cam on the existing fastener feed system is actuated that causes the fasteners to advance one at a time. Examples of the present disclosure are different from the existing fastener feed system, at least in part, because the actuator 40 continues to actuate until the control signal 73 is interrupted. In examples with the actuator 40 being a rotary actuator 40′, the rotary actuator 40′ continues to turn until the control signal 73 is interrupted. The control signal 73 may be responsive to a detection of a fastener 17 in the fastener installation head 12 by a fastener detection sensor 24. The fastener detection sensor 24 may be a proximity sensor 23. Thus, if a fastener 17 is not present in the installation head 12, the control signal 73 may cause the actuator 40 to continue to actuate until the fastener 17 is presented. A control system 74 may detect overload to determine that a jam has occurred and in response to jam detection, reduce the actuating force/torque to a force/torque that will not break the carrier ribbon 20.

As depicted in FIG. 1, the reel 16 turns clockwise as the strip 14 of fasteners 17 unwinds from the reel 16. The reel 16 may have a brake (not shown) to keep a small amount of tension on the strip 14 of fasteners 17 and prevent the strip 14 of fasteners 17 from unwinding faster than necessary, thereby preventing slack that can become tangled. The carrier ribbon 20 is threaded through the chute 36 via the chute inlet 34. The carrier ribbon 20 may have a leader (not shown) attached to the carrier ribbon 20 to assist in threading the feed apparatus 10. The leader may be a portion of the carrier ribbon 20 with no fasteners attached. Without a leader, the strip 14 of fasteners 17 may be manually fed into the chute inlet 34 by pushing the fasteners 17 until the strip 14 of fasteners 17 is observed through the aperture 38. The carrier ribbon 20 or the leader may be grasped with fingers or a grasping tool, for example, a needle nose pliers, and partially wound around the idler wheel 48 in a clockwise direction. Next the carrier ribbon 20 or the leader may be attached to the tensioner 30 to be advanced by the tensioner 30 by actuation of the actuator 40. In an example, the carrier ribbon 20 or the leader may be attached to the take-up spool 80 to be wound on the take-up spool 80 by clockwise rotation of the rotary actuator 40′.

FIG. 10 is a semi-schematic cross-sectional side view of another example of a feed apparatus of the present disclosure. FIG. 10 depicts a feed path of a strip 14 of fasteners 17 from a reel 16 through a chute 36 of the feed apparatus 10 into an installation head 12. As depicted in FIG. 10, the reel 16 turns counterclockwise as the strip 14 of fasteners 17 unwinds from the reel 16. The reel 16 may have a brake (not shown) to keep a small amount of tension on the strip 14 of fasteners 17 and prevent the strip 14 of fasteners 17 from unwinding faster than necessary, thereby preventing slack that can become tangled. The carrier ribbon 20 is threaded through the chute 36 via the chute inlet 34. The carrier ribbon 20 may have a leader (not shown) attached to the carrier ribbon 20 to assist in threading the feed apparatus 10. The leader may be a portion of the carrier ribbon 20 with no fasteners attached. Without a leader, the strip 14 of fasteners 17 may be manually fed into the chute inlet 34 by pushing the fasteners 17 until the strip 14 of fasteners 17 is observed through the aperture 38. The carrier ribbon 20 or the leader may be grasped with fingers or a grasping tool, for example, a needle nose pliers, and partially wound around the idler wheel 48 in a counterclockwise direction. Next the carrier ribbon 20 or the leader may be attached to the tensioner 30 to be advanced by the tensioner 30 by actuation of the actuator 40. In an example, the carrier ribbon 20 or the leader may be attached to the take-up spool 80 to be wound on the take-up spool 80 by counterclockwise rotation of the rotary actuator 40′. In other examples (not shown) the take-up spool 80 may be rotated in a clockwise direction by the rotary actuator 40′.

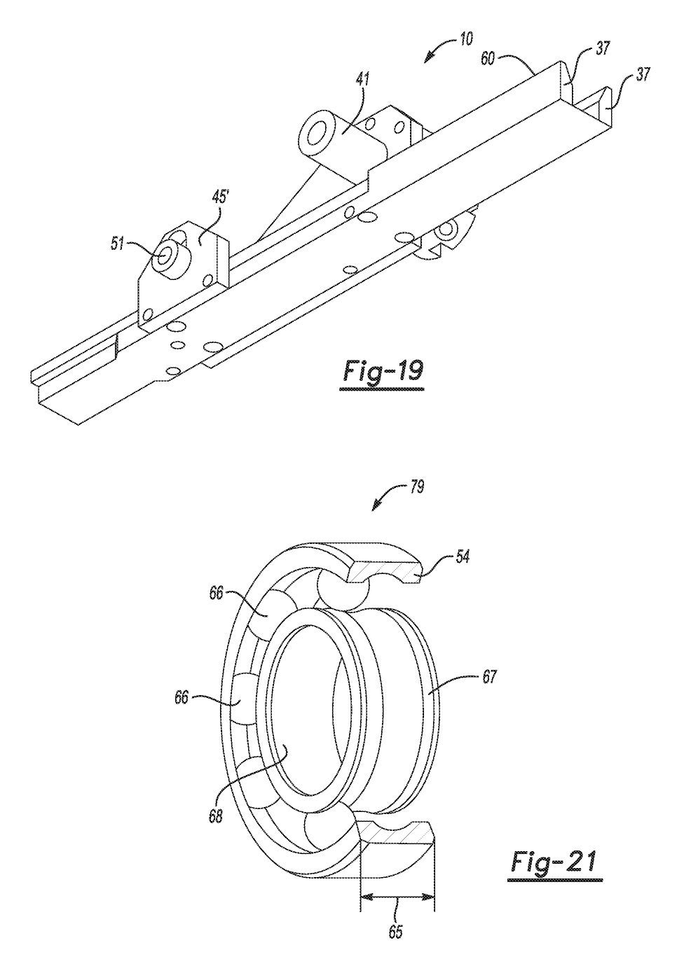

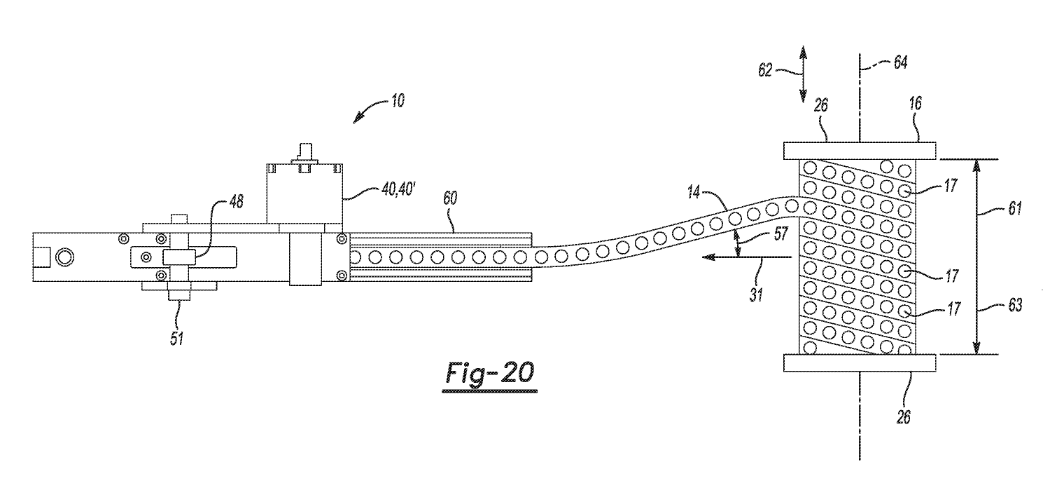

FIG. 11 is a top view of an example of a feed apparatus of the present disclosure. In the example depicted in FIG. 11, the actuator support bracket 43 is integrated with the support bracket 45 for the idler wheel 48 and attached on a side of the chute 36. A second support bracket 45′ is attached to the side of the chute 36 opposite the support bracket 45. In the example depicted in FIG. 11, the axle 51 of the idler wheel 48 is similar to a shoulder bolt. The axle 51 is disposed through a through-hole in the second support bracket 45′ and engages a threaded hole in the support bracket 45. In the example, the idler wheel 48 rotates on the axle 51 via an internal bearing 49. The idler wheel 48 shown in FIG. 11 is a double idler wheel 48 that includes two internal bearings 49 mounted side-by-side on the axle 51. The outer races 54 (see FIG. 21) of the internal bearings 49 form the outer surface of the idler wheel 48. Therefore, it is not necessary to have a separable bearing and wheel.

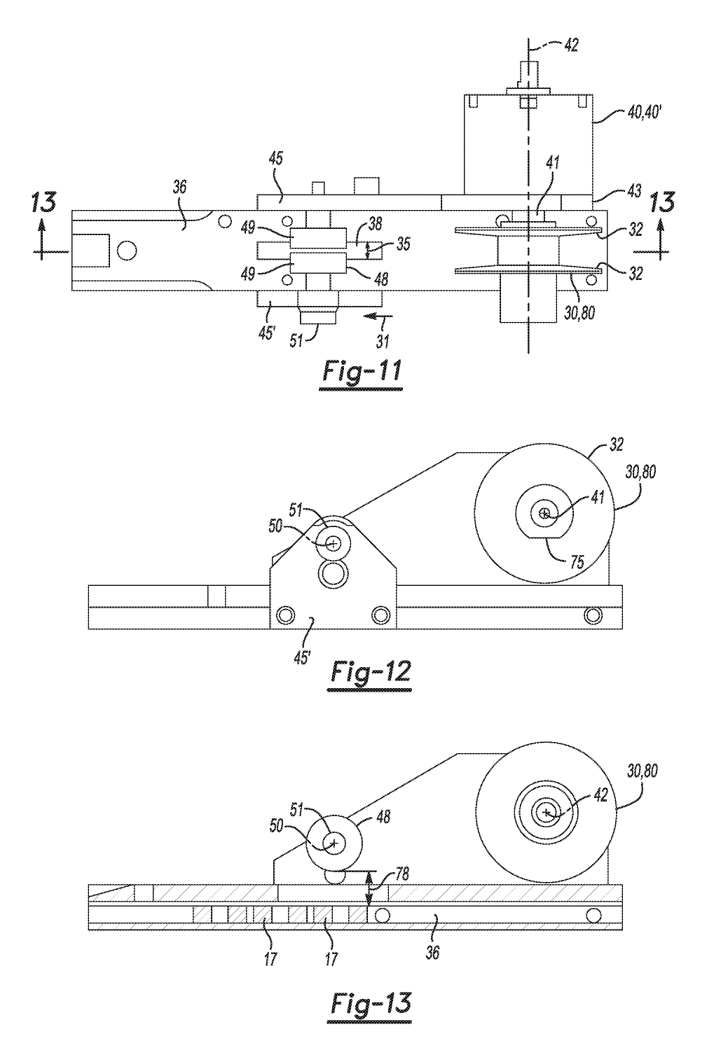

FIG. 12 is a side view of the example of the feed apparatus depicted in FIG. 11. FIG. 12 shows that the actuator shaft 41 has a keyed portion 75 with a flat section. The tensioner 30/take-up spool 80 has a complementary flat to mate with the keyed portion 75 of the actuator shaft 41. The tensioner 30/take-up spool 80 may be slidingly mounted on the actuator shaft 41 without a fastener. However, a fastener may be used to prevent the tensioner 30/take-up spool 80 from sliding off of the actuator shaft 41 during use. For example, a bolt with a wide flange washer may be installed in the actuator shaft 41. A spring clip, clamp, or adhesive tape may be used to prevent the tensioner 30/take-up spool 80 from sliding off of the actuator shaft 41 during use. In examples, when the take-up spool 80 is full of the empty carrier ribbon 20, the take-up spool 80 may be exchanged with an empty take-up spool 80. The empty carrier ribbon 20 may be reused or recycled.

FIG. 13 is a cross-sectional view taken along the line depicted in from FIG. 11. As depicted in FIG. 13, there may be a standoff distance 78 between the idler wheel 48 and the stream of fasteners 17 in the chute 36 that have had the carrier ribbon peeled therefrom. In other examples, the standoff distance 78 may be substantially eliminated by adjusting the location of the idler axis 50. Substantially eliminated means that there may be sufficient clearance to account for manufacturing variation to prevent the fasteners 17 from becoming jammed in the feed apparatus 10 at the idler wheel 48, and to prevent excess wear from the idler wheel 48 imparting excessive compressive loads at the fasteners 17. For example, the standoff distance 78 may be substantially eliminated when the standoff distance 78 is about 0.5 mm.

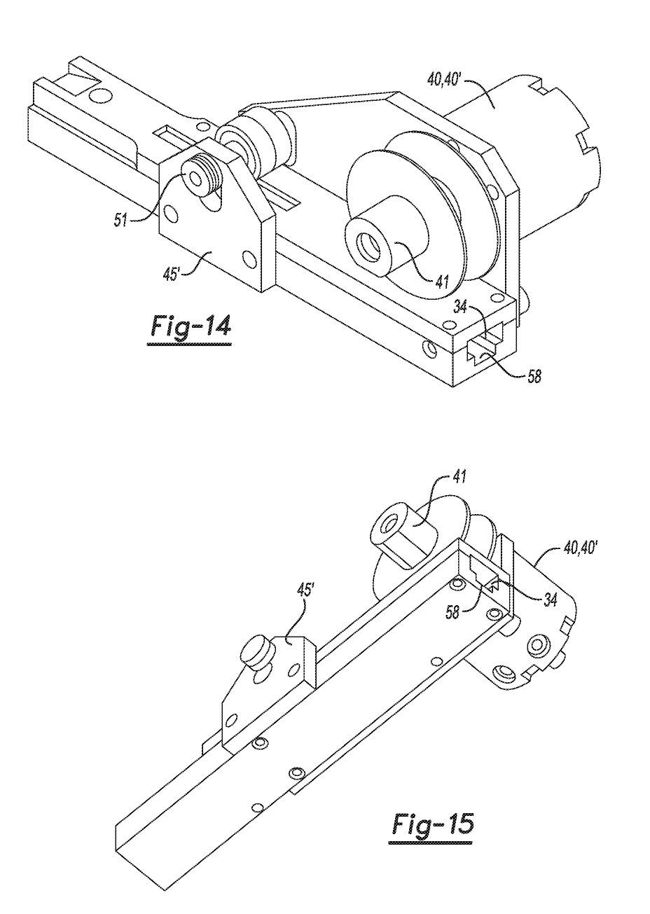

FIG. 14 is a perspective view of the example of the feed apparatus 10 depicted in FIG. 11. FIG. 15 is a bottom perspective view of the example of the feed apparatus depicted in FIG. 11. The chute 36 may be to prevent entry of an inverted fastener 17 into the chute 36. As used herein, an inverted fastener is a fastener that is upside down relative to the installation head 12. Some fasteners 17, for example the hex nut shown in FIG. 8D, are symmetrical and can be inverted without causing improper installation. In other examples, where the fastener 17 is a pierce nut, if an inverted fastener 17 is presented to the installation head 12, the inverted fastener 17 may not attach to the panel as expected. Therefore, blocking entry of an inverted fastener 17 into the chute 36 may cause overload to be detected and the actuator 40 may shut down to avoid damage. A detection of a jam may trigger an alarm to alert operating personnel that attention is required. The detection of a jam may also trigger a temporary shut-down of the installation head 12, and any related portion of a production line. In the example depicted in FIGS. 14-15, the chute inlet 34 may have a pilot groove 58 defined in the chute inlet 34 to admit a fastener 17 with a pilot 59 aligned with the pilot groove 58, and to block an inverted fastener 17 that is upside down so that the pilot 59 is not aligned with the pilot groove 58. In examples, the pilot groove 58 may be formed in a blocker plate (not shown) disposed at the chute inlet 34. When a blocker plate is used, it is not necessary to define the pilot groove 58 along the entire length of the chute 36.

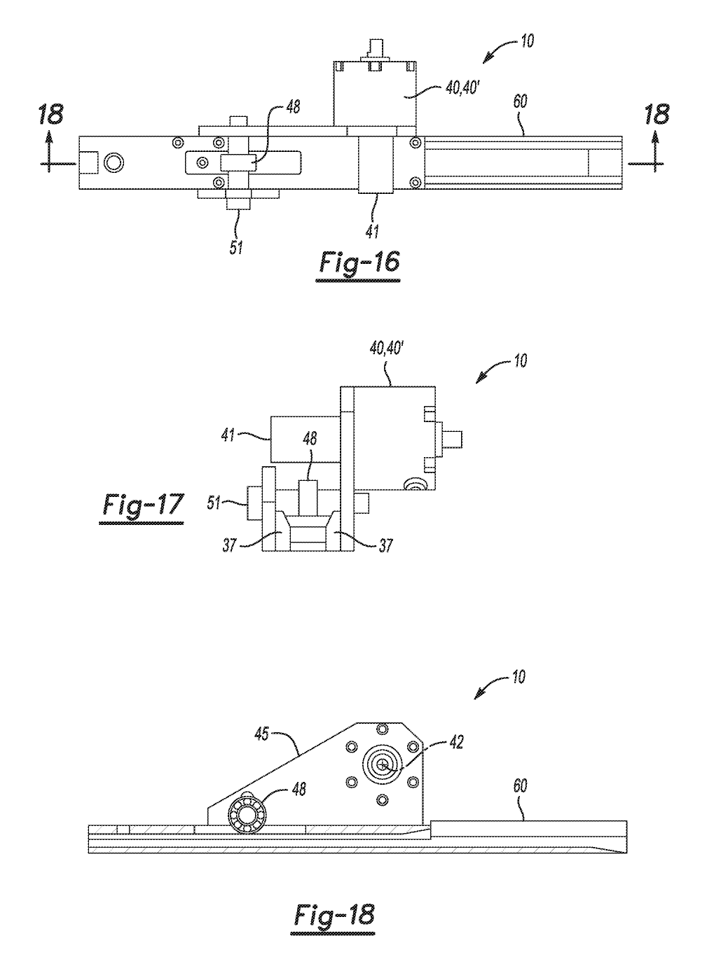

FIGS. 16-20 are views of another example of a feed apparatus 10 of the present disclosure. In the example depicted in FIGS. 16-20, a fastener alignment trough 60 aligns the strip 14 of fasteners 17 with the chute 36 (See also FIG. 1). The strip 14 of fasteners 17 may be wound on a reel 16 that has a spool width 61 that accommodates a single lane of fasteners 17. Such a reel would look similar to a movie film reel. However, to accommodate more fasteners 17 on a reel 16, the reel flanges 26 may be spaced far enough apart that the strip 14 of fasteners 17 may be wound in spirals along the traverse dimension 62 of the reel 16. The traverse dimension 62 is parallel to the reel axis of rotation 64. The distance between the reel flanges 26 is referred to as the traverse length 63. The strip 14 of fasteners 17 may be wound on the reel 16 in any suitable manner. For example, the strip 14 of fasteners 17 may be level wound, or random wound on the reel 16. The strip of fasteners 17 may dispense from the reel 16 oblique to the feed direction 31. The fastener alignment trough 60 has beveled walls 37 (best seen in FIG. 19) to redirect the strip 14 of fasteners 17 from an oblique angle 57 with the feed direction 31 into alignment with the feed direction 31 as shown in FIG. 20.

FIG. 21 is a semi-schematic perspective cutaway view of a ball bearing assembly 79, included herein to illustrate bearing nomenclature. The balls 66 rotate relative to the outer race 54 and the inner race 67. The bearing width is indicated at reference numeral 65. The bearing bore 68 is complementary to the axle 51. The bearing bore 68 may have a range of classes of fit from sliding fit to press fit on the axle 51.

It is to be understood that disclosure of any ranges herein is for convenience and brevity and should be interpreted flexibly to include not only the numerical values explicitly recited as the limits of the range, but also to include all the individual numerical values or sub-ranges encompassed within that range as if each numerical value and sub-range is explicitly recited. Furthermore, when “about” or “approximately” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

While several examples have been described in detail, it is to be understood that the disclosed examples may be modified. Therefore, the foregoing description is to be considered non-limiting.

What is claimed is:

1. A feed apparatus for feeding fasteners to a fastener installation head, comprising:
a chute to support and guide a strip of fasteners from a chute inlet to the fastener installation head, wherein the strip of fasteners includes a plurality of fasteners selectably releasably attached to a carrier ribbon, wherein the feed apparatus is to separate the fasteners from the carrier ribbon and present the fasteners to the fastener installation head for installation;
an idler wheel to peel the carrier ribbon from the fasteners as the fasteners pass through the chute;
a tensioner to advance the carrier ribbon and apply tension to the carrier ribbon to advance the fasteners in the chute; and
an actuator to urge the tensioner to advance the carrier ribbon.

2. The feed apparatus as defined in claim 1, wherein:
the chute has an aperture defined in a top surface;
the aperture has a width transverse to a feed direction of the chute;
the width of the aperture is smaller than a transverse dimension of the fasteners to prevent the fasteners from being withdrawn through the aperture; and
the carrier ribbon is to be drawn through the aperture and over the idler wheel, thereby peeling the carrier ribbon from the fasteners in seriatim.

3. The feed apparatus as defined in claim 2, further comprising a support bracket rigidly attached on a side of the chute to support an axle of the idler wheel wherein the axle of the idler wheel has an idler axis orthogonal to the feed direction of the chute.

4. The feed apparatus as defined in claim 3 wherein the idler wheel includes an internal bearing.

5. The feed apparatus as defined in claim 1, further comprising an actuator support bracket fixedly attached to the chute, wherein the actuator is mounted to the actuator support bracket and wherein the actuator has an actuator shaft having an actuator shaft axis orthogonal to a feed direction of the chute.

6. The feed apparatus as defined in claim 5 wherein the tensioner is removably mounted on the actuator shaft for advancement therewith.

7. The feed apparatus as defined in claim 1 wherein the actuator is a rotary actuator.

8. The feed apparatus as defined in claim 1 wherein the actuator is an electric motor.

9. The feed apparatus as defined in claim 1 wherein the actuator is an air motor.

10. The feed apparatus as defined in claim 1 wherein the chute is to prevent entry of an inverted fastener into the chute.

11. The feed apparatus as defined in claim 1 wherein:
the carrier ribbon is a plastic substrate with an adhesive layer disposed thereon; and
the fasteners are selectably removably adhesively attached to the carrier ribbon.

12. The feed apparatus as defined in claim 1 wherein:
the carrier ribbon is a flat plastic ribbon;
the carrier ribbon has a plurality of retention apertures defined therein; and
each fastener is disposed in a respective retention aperture and selectably releasably retained therein by resilience of the carrier ribbon.

13. The feed apparatus as defined in claim 1 wherein the fasteners are cylindrical or hexagonal.

14. The feed apparatus as defined in claim 1 wherein the fasteners are polygonal.

15. The feed apparatus as defined in claim 1 wherein the fasteners are free of burrs when presented to the fastener installation head.

16. The feed apparatus as defined in claim 1 wherein the actuator actuates the tensioner in response to a control signal and wherein the control signal is independent of a stroke of the fastener installation head.

17. The feed apparatus as defined in claim 16 wherein the control signal is responsive to a detection of a fastener in the fastener installation head by a fastener detection sensor.

18. The feed apparatus as defined in claim 17 wherein the fastener detection sensor is a proximity sensor.

19. The feed apparatus as defined in claim 1 wherein the fasteners are self-clinching or self-piercing fasteners.

20. The feed apparatus as defined in claim 19 wherein the strip of fasteners is unwound from a reel to be drawn into the chute inlet.
